(19) United States
(12) Patent Application Publication
(10) Pub. No.: US 2015/0334586 A1
(43) Pub. Date: Nov. 19, 2015

(54) WIRELESS RECEIVING APPARATUS AND METHOD

(71) Applicant: KABUSHIKI KAISHA TOSHIBA, Tokyo (JP)

(72) Inventors: Tsuyoshi KOGAWA, Kawasaki Kanagawa (JP); Tomoya TANDAI, Tokyo (JP)

(73) Assignee: KABUSHIKI KAISHA TOSHIBA, Tokyo (JP)

(21) Appl. No.: 14/710,532

(22) Filed: May 12, 2015

(30) Foreign Application Priority Data
May 16, 2014 (JP) 2014-102780

(51) Int. Cl. H04W 24/08; H04W 76/02; H04B 1/10; H04W 52/24

(52) U.S. Cl. CPC H04W 24/08; H04W 52/241; H04W 76/02; H04B 1/1027

(57) ABSTRACT

According to one embodiment, a wireless receiving apparatus includes a detector, a demodulator, a determination unit and a setting unit. The detector detects a wireless frame which has a received power level higher than a carrier detection threshold when the wireless frame is received. The determination unit determines a connection status in accordance with whether or not the demodulation is successful. The setting unit sets the carrier detection threshold at a first threshold if the connection status is an initial status where demodulation of a connection request frame is not successful, and which sets the carrier detection threshold at a second threshold if the connection status is other than the initial status, the second threshold being a variable value and larger than the first threshold.

### CROSS-REFERENCE TO RELATED APPLICATIONS

This application is based upon and claims the benefit of priority from Japanese Patent Application No. 2014-102780, filed May 16, 2014, the entire contents of which are incorporated herein by reference.

### FIELD

Embodiments described herein relate generally to a wireless receiving apparatus and method.

### BACKGROUND

In wireless communication, it is necessary to appropriately set a threshold for carrier detection (hereinafter, referred to as “a carrier detection threshold”) in order to perform carrier detection on a wireless frame appropriately. If the threshold is high, the probability of non-detection of a carrier (hereinafter, referred to as “a non-detection probability”) is increased even when a desired wireless frame is received, and communication quality is degraded. On the other hand, if the threshold is low, the probability that a signal is erroneously detected as a carrier of a wireless frame (hereinafter, referred to as “an erroneous detection probability”) is increased because of interference signals and noise, and communication quality is degraded. In the environment where no interference signals are present, only noise should be considered to decrease the erroneous detection probability, whereas in the environment where interference signals are present, the carrier detection is influenced by both interference signals and noise.

Accordingly, since a power level of an interference signal generally fluctuates, a procedure for adaptive setting of a carrier detection threshold is known.

However, in the procedure, the manner of setting a threshold does not change in response to the connection status of the wireless receiving apparatus, regardless of the susceptibility of the wireless receiving apparatus to interference. Thus, it is difficult to deal with interference flexibly, and the erroneous detection probability and the non-detection probability for a wireless frame cannot be adaptively decreased.

### BRIEF DESCRIPTION OF THE DRAWINGS

FIG. 1 is a conceptual diagram of two wireless systems.

FIG. 2 is a block diagram illustrating a wireless receiving apparatus according to the first embodiment.

FIG. 3 shows an example of a connection establishment sequence in a proximity system according to the present embodiment.

FIG. 4 shows a relationship between a non-detection probability and an erroneous detection probability.

FIG. 5 is a flowchart showing a threshold setting process at a threshold setting unit.

FIG. 6 is a diagram showing an example of a threshold setting process at a threshold setting unit according to the first embodiment.

FIG. 7 is a diagram showing an example of an operation of a wireless receiving apparatus according to the first embodiment.

FIG. 8 is a diagram showing an example of a threshold setting process at a threshold setting unit according to the second embodiment.

FIG. 9 is a block diagram illustrating a wireless receiving apparatus according to the third embodiment.

FIG. 10 is a diagram showing an example of an operation of a wireless receiving apparatus according to the third embodiment.

FIG. 11 is a conceptual diagram showing a conventional procedure of setting a carrier detection threshold.

### DETAILED DESCRIPTION

In general, according to one embodiment, a wireless receiving apparatus includes a detector, a demodulator, a determination unit and a setting unit. The detector detects a wireless frame which has a received power level higher than a carrier detection threshold when the wireless frame is received. The demodulator performs demodulation on the wireless frame. The determination unit determines a connection status between the wireless receiving apparatus and another apparatus in accordance with whether or not the demodulation is successful. The setting unit sets the carrier detection threshold at a first threshold if the connection status is an initial status where demodulation of a connection request frame is not successful, and which sets the carrier detection threshold at a second threshold if the connection status is other than the initial status, the first threshold being a fixed value, the second threshold being a variable value and larger than the first threshold.

In the following, the wireless receiving apparatus and method according to one of the embodiments of the present disclosure will be described in detail with reference to the drawings. In the embodiment described below, elements specified by the same reference numbers carry out the same operations, and a duplicate description of such elements will be omitted.

### First Embodiment

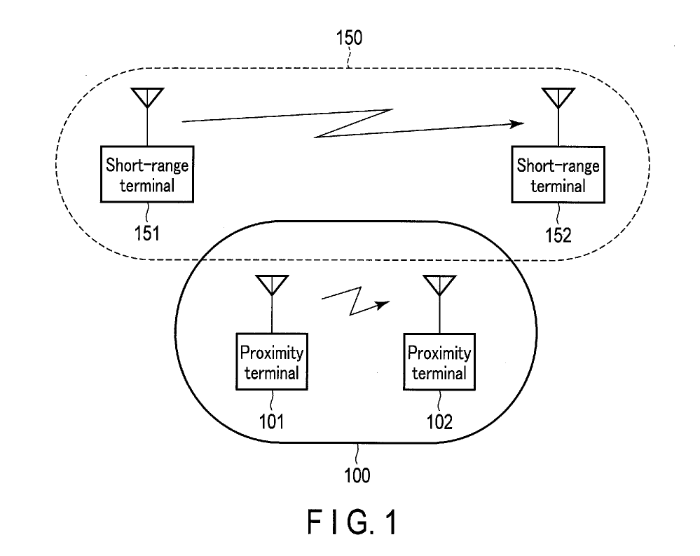

Two wireless systems assumed in the present embodiment are explained with reference to FIG. 1.

FIG. 1 shows a proximity terminal 101, a proximity terminal 102, a short range terminal 151, and a short range terminal 152.

The proximity terminal 101 and the proximity terminal 102 are specialized in point-to-point communication using the 60 GHz frequency band, for example, and are used in a proximity millimeter wave wireless system (hereinafter referred to as “the proximity system 100”) that communicates in the range of a few centimeters.

Herein, the proximity terminal 101 transmits a wireless frame to the proximity terminal 102 using the 60 GHz frequency band, and performs data communication.

The short range terminal 151 and the short range terminal 152 are used in a short-range millimeter wave wireless system (hereinafter referred to as “the short range system 150”) using, for example, the 60 GHz frequency band. As an example of such a short range system 150, a system compliant to the international standard specification, typified by WiGig/IEEE802.11ad having the communication range of a few meters, may be adopted. Herein, the proximity terminal 151 transmits a wireless frame to the proximity terminal 152 using the 60 GHz frequency band, and communicates data.

If the proximity system 100 and the short range system 150 are present in the same area, the proximity system 100 is relatively more susceptible to interference in terms of their communication ranges because the service area of the short range system 150 is larger than that of the proximity system 100. Hereinafter, a wireless frame transmitted by the proximity terminal is called a desired signal, and a wireless frame transmitted by the short range terminal is called an interference signal.

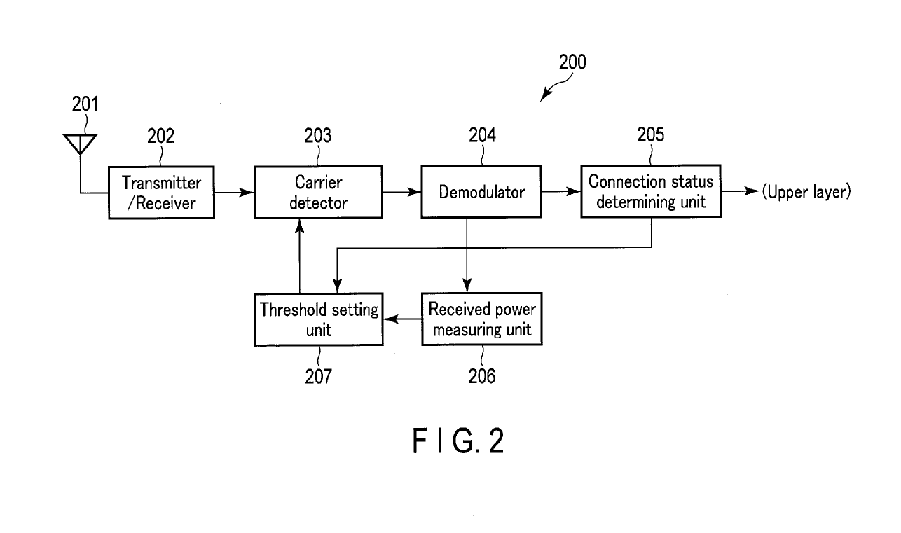

Next, the wireless receiving apparatus according to the first embodiment is explained with reference to the block diagram of FIG. 2. The wireless receiving apparatus is used as the proximity terminal 102 shown in FIG. 1, for example.

The wireless receiving apparatus 200 according to the first embodiment includes an antenna 201, a transmitter and receiver 202, a carrier detector 203, a demodulator 204, a connection status determining unit 205, a received power measuring unit 206, and a threshold setting unit 207.

A regular antenna can be used as the antenna 201 for wireless communication to transmit and receive wireless signals in the 60 GHz frequency band, therefore a further explanation of the antenna 201 is omitted. Although FIG. 2 shows one antenna 201 only, the apparatus may comprise more than one antenna.

The transmitter and receiver 202 receives a wireless frame from a communication partner apparatus (a proximity terminal) via the antenna 201. The transmitter and receiver 202 transmits an ACK frame, etc. which is a wireless frame indicating a response to the other apparatus.

The carrier detector 203 receives the wireless frame from the transmitter and receiver 202, and determines whether or not the received power level of the wireless frame is higher than the carrier detection threshold when the radio frame received. If the received power level is higher than the carrier detection threshold, it is determined that a carrier is detected, and a carrier detection result is obtained. When a new threshold is set by the threshold setting unit 207 (will be described later), the carrier detector 203 updates the current carrier detection threshold to a new threshold.

The demodulator 204 receives the carrier detection result and the detected wireless frame from the carrier detector 203, and demodulates the wireless frame for which a carrier seems to have been detected based on the carrier detection result to obtain a demodulation result. The demodulator 204 generates a gain controlled by performing automatic gain control (AGC) when the wireless frame is demodulated, and generates an analog-to-digital converter (ADC) output of a preamble that is obtained after the AGC.

The connection status determining unit 205 receives a demodulation result from the demodulator 204, and determines whether the demodulation result is correct or not. The demodulation result determination, may be, for example, whether cyclic redundancy check (CRC) information added to the wireless frame is correct or not. In the following, “the demodulation result is correct” may be expressed as “the demodulation is successful”. If the demodulation is successful, the connection status determining unit 205 can obtain information on a frame type of the demodulated wireless frame. The frame types are, for example, a connection request frame indicating a connection request from another apparatus, an ACK frame, and a data frame including data body.

The connection status determining unit 205 obtains information regarding whether the demodulation is successful or not, and obtains a frame type as a determination result. The connection status determining unit 205 determines a connection status between the wireless receiving apparatus 200 and the communication partner apparatus in accordance with the determination result. As a connection status, the present embodiment assumes three statuses: an initial status, an intermediate status, and a connection establishment status. An initial status refers to a status where demodulation has not yet been successfully performed on a connection request frame indicating a connection request from another apparatus. An intermediate status refers to a status between the time when demodulation of the connection request frame is successfully performed and the time when a connection with another apparatus is established. A connection establishment status refers to the time when the connection with the other apparatus is established and thereafter. The connection statuses are not limited to those explained above; there may be more than three statuses including the initial status, or may be just the initial status and the connection establishment status.

The connection status determining unit 205 outputs a control signal to the transmitter and receiver 202 to transmit an ACK, etc. in accordance with the demodulation result and the connection status, and outputs a control signal to an upper layer to receive an instruction signal from the upper layer.

The received power measuring unit 206 receives the gain and the ADC output from the demodulator 204, and measures a received power value of the wireless frame based on the gain and the ADC output. The received power can be measured by calculating a received signal strength indicator (RSSI). As the calculation of the RRSI is a well-known procedure, the explanation thereof is omitted.

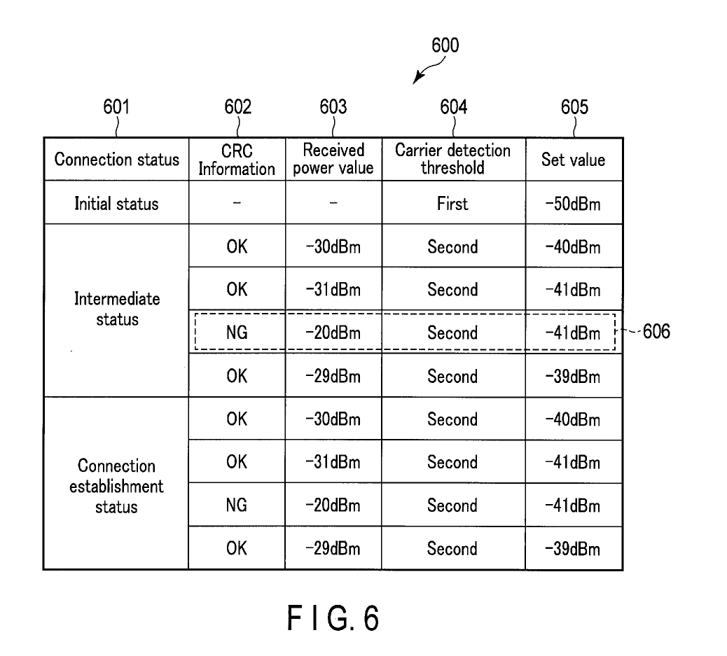

The threshold setting unit 207 receives the determination result and the connection status from the connection status determining unit 205, and the received power value from the received power measuring unit 206. Based on the determination result, the connection status, and the received power value, the threshold setting unit 207 determines, of a first threshold value that is a fixed value, and a second threshold that is variable and larger than the first threshold, the carrier detection threshold that should be used at the carrier detector 203. The details of the setting of the carrier detection threshold will be described later with reference to FIG. 6.

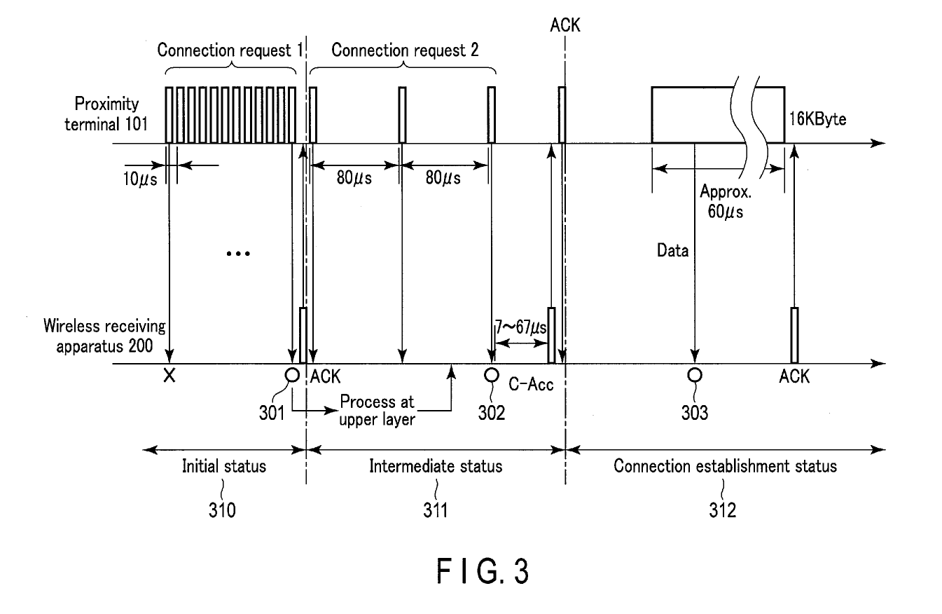

Next, an example of the connection establishment sequence of the proximity system according to the present embodiment is explained with reference to FIG. 3.

FIG. 3 shows a time series from the time when the proximity terminal 101 establishes a connection with a proximity terminal 102 (the wireless receiving apparatus 200) to the time when data is transmitted. The arrow from the proximity terminal 101 to the wireless receiving apparatus 200 and the arrow from the wireless receiving apparatus 200 to the proximity terminal 101 each indicate transmission of a wireless frame to a communication partner apparatus.

In the initial status 310, the proximity terminal 101 continuously transmits, as a connection request 1, a connection request frame having the length of 4 microseconds every 10 microseconds for 1 millisecond until it receives a response from the wireless receiving apparatus 200. In other words, the proximity terminal 101 transmits a connection request 1 to the wireless receiving apparatus 200 by burst transmission. Suppose the wireless receiving apparatus 200 is not able to receive the connection request frame for the connection request 1 from the proximity terminal 101 at first because of interference signals, etc., but at timing 301, the wireless receiving apparatus 200 becomes able to receive the connection request frame for the connection request 1 for the first time.

If the received connection request frame for the connection request 1 is successfully demodulated, the wireless receiving apparatus 200 transmits an ACK frame to the proximity terminal 101 as a response to the received connection request frame. At this time, the connection status shifts from the initial status 310 to the intermediate status 311. While the ACK frame is being transmitted, it is checked if the wireless receiving apparatus 200 is connectable to the proximity terminal 101 at the upper layer of the wireless receiving apparatus 200.

After receiving the ACK frame from the wireless receiving apparatus 200, the proximity terminal 101 continuously transmits a connection request frame for a connection request 2 every 80 microseconds until it receives a response from the wireless receiving apparatus 200. The connection request frame that is transmitted as the connection request 1 and the connection request frame that is transmitted as the connection request 2 are wireless frames including similar data, except that the connection request 1 requires an ACK frame from a communication partner.

If the upper layer determines that the wireless receiving apparatus 200 is connectable to the proximity terminal 101, after receiving the connection request frame for the connection request 2 (timing 302), the wireless receiving apparatus 200 transmits a connection accept frame indicating it can connect to the proximity terminal 101.

When the proximity terminal 101 receives the connection response frame from the wireless receiving apparatus 200, the proximity terminal 101 transmits an ACK frame to the wireless receiving apparatus 200.

Upon receiving of the ACK frame from the proximity terminal 101 at the wireless receiving apparatus 200, a connection is established, and the connection status shifts from the intermediate status 311 to the connection establishment status 312.

In the connection establishment status 312, the proximity terminal 101 transmits a data frame including data body to the wireless receiving apparatus 200. The wireless receiving apparatus 200 receives the data frame (timing 303), and transmits an ACK frame indicating the completion of receiving the data frame to the proximity terminal 101, and then demodulates the data body in the data frame for a process at the upper layer.

It should be noted that, in the initial status 310, the frame length of the connection request frame for the connection request 1 received by the wireless receiving apparatus 200 is 4 microseconds, which is shorter than the frame length of the data frame, and the connection request frame is transmitted in a short cycle of about 10 microseconds by burst transmission. In other words, even if there are interference signals, there is a high possibility that the connection request frame can be received at a timing when an interference signal is interrupted, and thus, the wireless receiving apparatus 200 can succeed in demodulating the connection request frame.

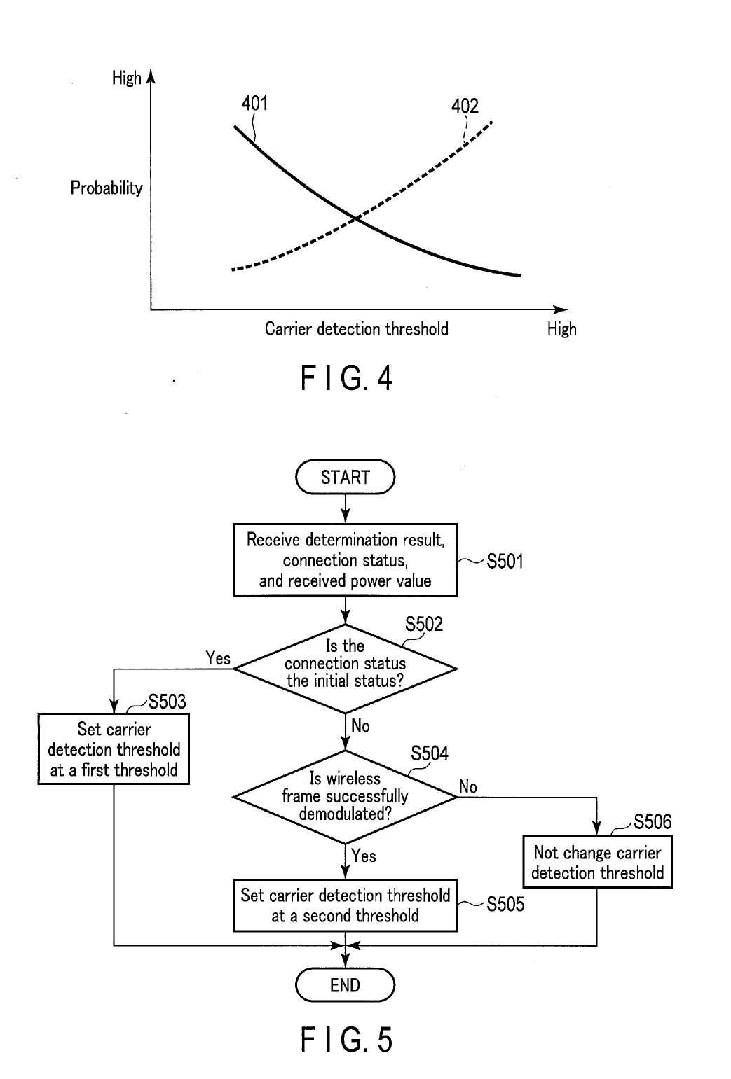

Next, the relationship between the non-detection probability and the erroneous detection probability is explained with reference to FIG. 4.

FIG. 4 is a graph indicating an erroneous detection probability 401 and a non-detection probability 402 for the carrier detection threshold. The horizontal axis indicates a carrier detection threshold, and the vertical axis indicates a probability. If the carrier detection threshold is low, the erroneous detection probability 401 becomes higher, whereas the non-detection probability becomes lower. If the carrier detection threshold is high, the erroneous detection probability 401 becomes lower, whereas the non-detection probability 402 becomes higher. Thus, the relationship between the erroneous detection probability 401 and the non-detection probability 402 is a trade-off.

If the connection status is the initial status, it is necessary to detect a wireless frame at a wireless receiving apparatus if at all possible, even if the distance between the terminals is great; thus, a low non-detection probability is desirable. In the proximity system assumed in the present embodiment, the connection request frame as the connection request 1 is a short frame and is continuously transmitted. For this reason, even if a carrier is erroneously detected, the possibility to recover the erroneous detection of frames is high. On the other hand, when the connection status is other than the initial status, it is desirable to keep the erroneous detection probability low in order to improve throughput.

Next, the threshold setting process at the threshold setting unit 207 according to the first embodiment is explained with reference to the flowchart shown in FIG. 5. The steps shown in FIG. 5 are performed for each wireless frame in which a carrier is detected.

At step S501, the threshold setting unit 207 receives the determination result and the connection status from the connection status determining unit 205, and receives the received power value from the received power measuring unit 206.

At step S502, the threshold setting unit 207 determines whether the connection status is the initial status or not. If the connection status is the initial status, the process proceeds to step S503. If the connection status is one other than the initial status, i.e. the intermediate status or the connection establishment status, the process proceeds to step S504.

At step S503, the threshold setting unit 207 sets the carrier detection threshold at the first threshold.

At step S504, the threshold setting unit 207 determines whether the wireless frame (a connection requesting frame or a data frame) has been successfully demodulated or not, referring to the determination result. If the demodulation is successful, the process proceeds to step S505. If the demodulation is not successful, the process proceeds to step S506.

At step S505, the threshold setting unit 207 sets the carrier detection threshold at the second threshold. The second threshold can, for example, be determined at a value obtained by subtracting a necessary signal-to-interference-plus-noise ratio (hereinafter referred to as “the required SINR”), which is required to extract a desired signal, from a received power value of the latest wireless frame which has been successfully demodulated.

At step S506, the threshold setting unit 207 does not change the carrier detection threshold because the demodulation is not successful. The control process at the threshold setting unit 207 is finished.

Next, a specific example of the setting process at the threshold setting unit 207 according to the first embodiment is explained with reference to FIG. 6.

FIG. 6 is an example of a table which is referred to when a carrier detection threshold is set at the threshold setting unit 207. Such a table format is not necessarily used to determine a carrier detection threshold. A method for determining a carrier detection threshold in accordance with a received power and a determination result (CRC information) is not limited to one disclosed herein.

In the table 600, a connection status 601, CRC information 602, a received power value 603, carrier detection threshold information 604, and a set value 605 are presented. Each of the elements is calculated for each wireless frame, and associated uniquely with each wireless frame.

The connection status 601 is the connection status determined by the connection status determining unit 205. In the present embodiment, the connection status 601 is any one of the initial status, the intermediate status, and the connection establishment status.

The CRC information 602 is the determination result obtained at the connection status determining unit 205. The CRC information 602 in the table indicates whether the CRC information is correct or not, i.e., whether the demodulation is successful or not. “OK” means the CRC information is correct (the demodulation is successful), and “NG” means the CRC information 602 is wrong (the demodulation is not successful).

The received power value 603 is the received power measured by the received power measuring unit 206.

The carrier detection threshold information 604 is information indicating which of the first threshold and the second threshold is used as the carrier detection threshold.

The set value 605 is a value which is set as the first threshold or the second threshold. The first threshold is a fixed value as mentioned above, and herein it is set at −50 dBm. The second threshold is a variable value used during a connection status other than the initial status, and herein it varies within the range between −50 dBm and −10 dBm. The required SINR is set at 10 dBm in the present embodiment; however, it can be changed in accordance with a system's modulation rate, as needed. For example, if a modulation rate is high, an SINR may be set at 20 dBm, which is higher than the required SINR at 10 dBm; if a modulation rate is low, an SINR may be set at 2 dBm, which is lower than the required SINR.

During the initial status, the threshold is set at a low value if at all possible to decrease the non-detection probability. In other words, the carrier detection threshold is set at the first threshold.

During the intermediate status, if the CRC information 602 of the immediately previous wireless frame indicates “OK”, the second threshold is used as the carrier detection threshold, and the set value 605 is calculated based on the received power value 603 and the required SINR.

Specifically, if the received power value 603 when the CRC information 602 indicates “OK” is “−30 dBm”, a value obtained by subtracting the required SINR (10 dBm) from the received power (i.e., “−30 dBm−10 dBm=−40 dBm) is set as the set value 605.

On the other hand, if the CRC information 602 indicates “NG”, the carrier detection threshold is not changed. Specifically, if the CRC information 602 indicates “NG” (see the frame 606 shown in FIG. 6), the carrier detection threshold of the immediately previous wireless frame for which demodulation is successful, −41 dBm is used without changing the value.

During the connection establishment status, the second threshold is used as the carrier detection threshold, and the set value 605 is set similarly to the process during the intermediate status.

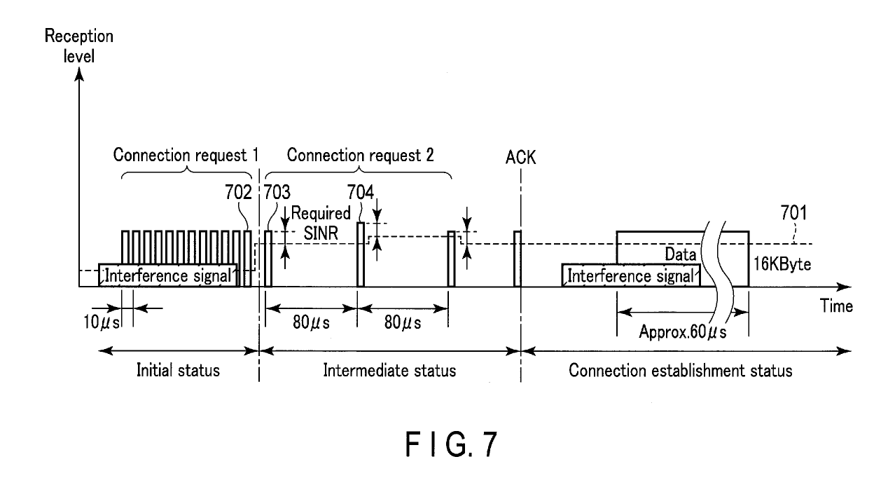

Next, an example of the operation of the wireless receiving apparatus 200 according to the first embodiment is described with reference to FIG. 7.

FIG. 7 exclusively shows the time series of the reception of wireless frames at the wireless receiving apparatus 200. The horizontal axis indicates time, and the vertical axis indicates a received power level. The broken line along the time series shown in FIG. 7 represents the carrier detection threshold 701.

If the connection status is the initial status, the carrier detection threshold is set at the first threshold. When the connection request frames for a connection request 1 are received from a communication partner, the reception is affected by interference signals from other wireless systems which are at a received power level higher than that of the carrier detection threshold 701. Thus, the early connection request frames for the connection request 1 cannot be received. Then, the connection request frame 702 for the connection request 1 is received at the timing when there is no interference signal while burst transmission of the connection request 1 is carried out.

Then, during the intermediate status, the carrier detection threshold is set at the second threshold, and the second threshold is set based on a received power of the received connection request frame for the connection request 2. When the connection request frame 703 is received, a value obtained by subtracting the required SINR from the received power of the connection request frame 703 is set as the second threshold. Since the received power of the subsequent connection request frame 704 is higher than that of the connection request frame 703, the second threshold is set at a higher value.

According to the first embodiment described above, the non-detection probability can be decreased by fixing the carrier detection threshold at a low value during the initial status, and the demodulation of a wireless frame can be successfully performed during a gap between interference signals regardless of erroneous detection caused by interference signals, because short wireless frames are repeatedly received in a short time cycle. On the other hand, during a connection status other than the initial status, the reception is easily affected by interference signals because long wireless frames are received; however, it is possible to reduce the influence of interference signals and decrease the erroneous detection probability by setting a variable value as a carrier detection threshold in accordance with a received power level of an immediately previous wireless frame for which demodulation is successful.

### Second Embodiment

In the second embodiment, received power levels of received wireless frames are averaged to set a second threshold. By calculating a second threshold based on an average received power level and setting the second threshold as a carrier detection threshold, it is possible to make the carrier detection threshold more reliable.

As the wireless receiving apparatus according to the second embodiment is the same as that of the first embodiment, except for the operation at the wireless receiving apparatus 200 and the threshold setting unit 207, an explanation thereof is omitted.

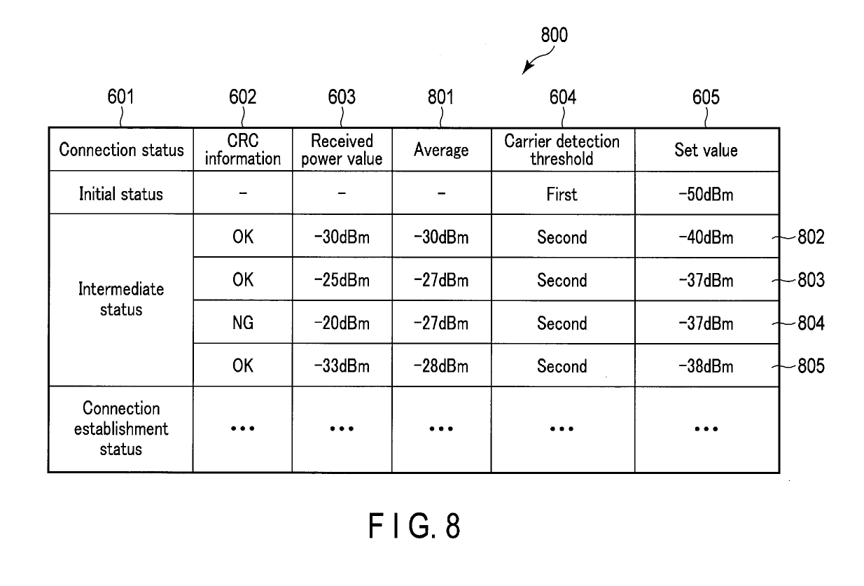

A specific example of the operation at the threshold setting unit 207 according to the second embodiment is explained with reference to FIG. 8.

In the table 800 shown in FIG. 8, a connection status 601, CRC information 602, a received power value 603, carrier detection threshold information 604, a set value 605, and an average 801 are presented.

The connection status 601, the CRC information 602, the received power value 603, the carrier detection threshold information 604, and the set value 605 are the same as those presented in the table 600 shown in FIG. 6.

The average 801 is a value obtained by averaging the received power value 603 of a wireless frame in which the connection status is the intermediate status and the CRC information 602 indicates “OK”.

Specifically, for example, during the connection request frame 802, the CRC information 602 indicates “OK”, but it is the first wireless frame in the intermediate status; thus, in this case, the received power is not averaged. The required SINR “10 dBm” is subtracted from the received power value 603 “−30 dBm”, and thus the set value 605 for the second threshold is “−40 dBm”.

Subsequently, when the connection request frame 803 is received, the CRC information 602 indicates “OK”, and the average of the received power values is calculated. Specifically, for example, an average of the received power of the connection request frame 802 and that of the connection request frame 803 is calculated as follows: 0.001 mW (−30 dBm)+0.003162 mW (−25 dBm))/2≈0.002081 mW (−26.817 dBm). Herein, a value is rounded off to the nearest integer. The set value 605 as the second threshold is −37 dBm which is obtained by subtracting the required SINR (10 dBm) from −27 dBm.

Subsequently, a connection request frame 804 is received. Since the CRC information 602 indicates “NG”, the setting value 605 remains at −37 dBm.

Then, when a connection request frame 805 is received, since the CRC information 602 indicates “OK”, an average of the received power of a previous connection request frame for which the CRC information indicates “OK” and the received power of the present connection request frame 805 is calculated. Specifically, an average of the connection request frames 802, 803, and 805 is calculated as follows: (0.001 mW (−30 dBm)+0.003162 mW (−25 dBm)+0.000501 mW (−33 dBm)/3≈0.001554 mW (−28.0841 dBm)). Therefore, the set value 605 for the second threshold is determined as −38 dBm, which is obtained by subtracting the required SINR from the average as calculated above.

The process of averaging the received power values is carried out not only when the connection status is the intermediate status, but also after the connection status is shifted to the connection establishment status.

According to the second embodiment as described above, it is possible to set a carrier detection threshold at a more reliable value if a second threshold is set using an average of received wireless frames of connection requests which are periodically received in a situation where the wireless receiving apparatus waits for a process at an upper layer. Thus, it is possible to reduce the influence of interference signals and to decrease an erroneous detection probability.

### Third Embodiment

In the third embodiment, a threshold is set using a timer. By using a timer, it is possible to avoid a situation where no detection of wireless frames successively occurs.

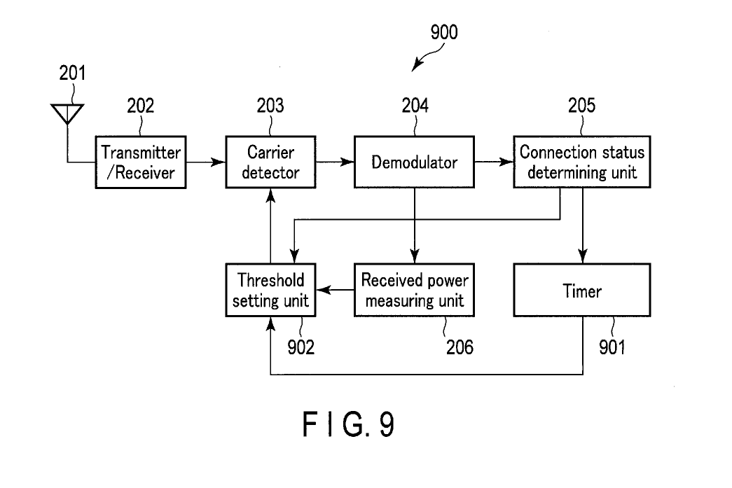

The wireless receiving apparatus according to the third embodiment will be explained with reference to FIG. 9.

The wireless receiving apparatus 900 according to the third embodiment includes an antenna 201, a transmitter and receiver 202, a carrier detector 203, a demodulator 204, a connection status determining unit 205, a received power measuring unit 206, a timer 901, and a threshold setting unit 902.

The operations of the antenna 201, the transmitter and receiver 202, the carrier detector 203, the demodulator 204, the connection status determining unit 205, and the received power measuring unit 206 are the same as those in the first embodiment, and descriptions thereof will be omitted.

The timer 901 receives a determination result and a connection status from the connection status determining unit 205. When the connection status shifts from the intermediate status to the connection establishment status, the timer 901 initiates and begins measuring time. Also, when the CRC information included in the determination result indicates “OK”, i.e., when the demodulation is successful, the timer 901 resets a timer and begins measuring time again. When the elapsed time measured by the timer exceeds a predetermined length of time, the timer 901 generates timeout information to indicate a timeout.

When the threshold setting unit 902 receives timeout information from the timer 901, if the connection status is the connection establishment status, the threshold setting unit 902 sets a carrier detection threshold at the first threshold. The threshold setting unit 902 can be operated in almost the same operation as the threshold setting unit 207 according to the foregoing embodiments, except when it receives timeout information from the timer 901.

A proximity system in which the wireless receiving apparatus according to the present embodiment is adopted may be designed to reset the connection status to the initial status in accordance with a timeout period set by a timer on the system side if a period during which demodulation is not successful continues. In this case, a predetermined period of time set at the timer unit 901 should be set shorter than the time out period set at a timer of the proximity system so that the process at the wireless receiving apparatus according to the third embodiment should be prioritized.

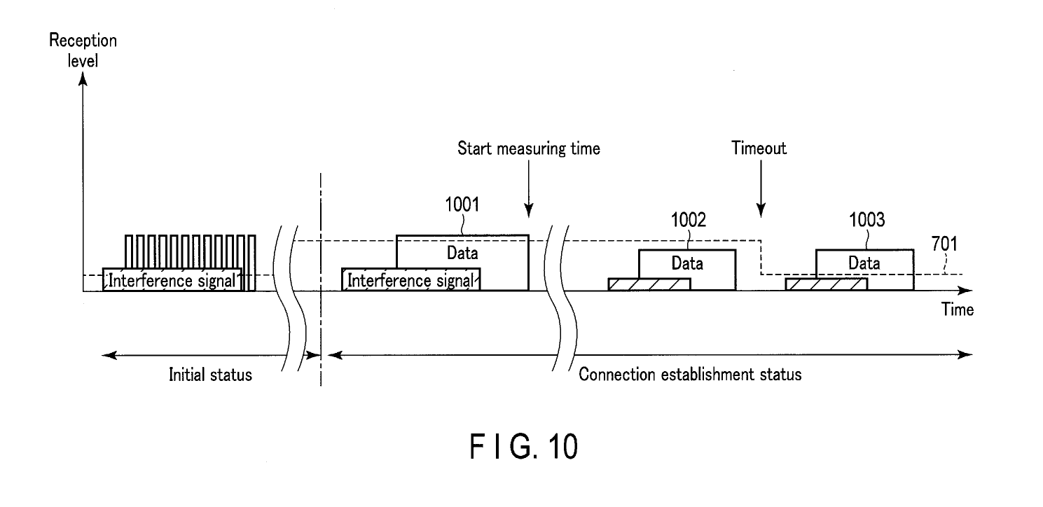

Next, the control of the carrier detection threshold at the wireless receiving apparatus 900 according to the third embodiment is explained with reference to FIG. 10.

FIG. 10 exclusively shows the time series of the reception of wireless frames at the wireless receiving apparatus 900, and it is similar to FIG. 7.

In the connection establishment status, similar to the foregoing embodiments, the carrier detection threshold 701 is set at the second threshold, and the second threshold changes in accordance with the received power value of the wireless frame for which demodulation is successful. When the demodulation of the wireless frame (data frame 1001) is successful, the timer 901 resets and begins measuring the elapsed time.

If a distance between the wireless receiving apparatus and the communication partner device increases after the successful demodulation of the data frame 1001, a received power value of a data frame 1002 received by the wireless receiving apparatus 900 will decrease. Since the received power value of the data frame 1002 is smaller than the carrier detection threshold, demodulation of the data frame 1002 will not be successful.

If such failure of demodulation continues after the measuring of the elapsed time begins, and when a predetermined period of time has elapsed, the threshold setting unit 902 changes the carrier detection threshold 701 from the second threshold to the first threshold. Thus, the received power value of the data frame 1003 becomes larger than the carrier detection threshold, and the data frame 1003 can be demodulated successfully.

According to the third embodiment as described above, the carrier detection threshold is set at the second threshold during the connection establishment status, and it is set back to the first threshold that is a minimum value if a certain period of time is elapsed when no detection of a desired signal occurs because of a sudden change of a distance between the wireless receiving apparatus and the communication partner device. Thus, it is possible to avoid a situation where no detection of a wireless frame successively occurs.

### Conventional Example

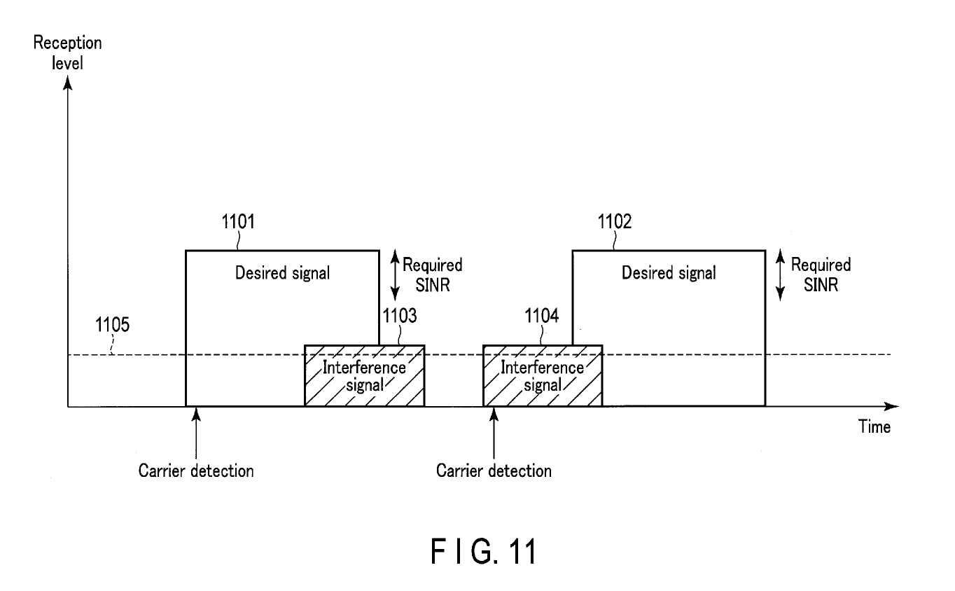

Next, the influence of interference signals in a proximity system compliant with a conventional procedure for setting a carrier detection threshold will be explained with reference to the conceptual drawing shown in FIG. 11.

In FIG. 11, the horizontal axis is time, and the vertical axis is a received power level. The broken line shown in FIG. 11 represents the carrier detection threshold 1105.

When a proximity terminal determines that the received power level of a desired signal 1101 is higher than a carrier detection threshold 1105, the proximity terminal performs a synchronization process such as AGC and an automatic frequency control (AFC) on a preamble of the desired signal 1101 to demodulate data which is received after the preamble. In the example shown in FIG. 11, although an interference signal 1103 is received at the latter half of the desired signal 1101, the proximity terminal can succeed in demodulating the data because the desired signal 1101 satisfies the required SINR.

Subsequently, the proximity terminal receives an interference signal 1104. Since the received power level of interference signal 1104 is higher than a carrier detection threshold 1105, a synchronization process such as AGC and AFC is performed on the interference signal 1104. Herein, the received power level and waveform level of the interference signal 1104 are different from those of the preamble included in a desired signal 1102, and thus, the synchronization process on the interference signal cannot be performed successfully. At this time, even if the desired signal 1102 is received at the latter half of the interference signal 1104, the synchronization process cannot be carried out, and the demodulation of the desired signal 1102 is not successful. In other words, even if the desired signal 1102 satisfies the required SINR of the wireless receiving apparatus 200, the interference signal 1104 becomes higher than the carrier detection threshold 1105 earlier than the desired signal 1102 does; thus, the demodulation of the desired signal 1102 is not successful.

On the other hand, with the wireless receiving apparatus according to the present embodiment, it is possible to reduce the influence of interference signals and decrease the erroneous detection probability by setting a carrier detection threshold in accordance with a received power level of a wireless frame for which demodulation is successful.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless receiving apparatus, comprising:
a detector which detects a wireless frame which has a received power level higher than a carrier detection threshold when the wireless frame is received;
a demodulator which performs demodulation on the wireless frame;
a determination unit which determines a connection status between the wireless receiving apparatus and another apparatus in accordance with whether or not the demodulation is successful; and
a setting unit which sets the carrier detection threshold at a first threshold if the connection status is an initial status where demodulation of a connection request frame is not successful, and which sets the carrier detection threshold at a second threshold if the connection status is other than the initial status, the first threshold being a fixed value, the second threshold being a variable value and larger than the first threshold.

2. The apparatus according to claim 1, further comprising a measuring unit which measures a received power value of the wireless frame for which the demodulation is successful,
wherein the setting unit determines the second threshold based on a required signal-to-interference noise ratio and the received power value if the connection status is other than the initial status.

3. The apparatus according to claim 2, wherein if one or more successfully-demodulated wireless frames are acquired, the setting unit determines the second threshold using a received power value of a latest wireless frame among the one or more successfully-demodulated wireless frames.

4. The apparatus according to claim 2, wherein if one or more successfully-demodulated wireless frames are acquired, the setting unit calculates an average of the received power values of the one or more successfully-demodulated wireless frames, and determines the second threshold based on the average.

5. The apparatus according to claim 1, further comprising a receiver which receives one or more wireless frames,
wherein a frame length of the connection request frame is shorter than a frame length of a data frame, and one or more connection request frames are successively transmitted from the another apparatus at a first interval within a first period,
if the connection status is the initial status, the setting unit successively receives the one or more connection request frames until the demodulation is successful.

6. The apparatus according to claim 1, further comprising a timer which measures an elapsed time if the connection status is a connection establishment status where a connection between the wireless receiving apparatus and the another apparatus is established, the elapsed time being a time since the connection status has been shifted to a connection establishment status, or a time since the demodulation has been successfully performed,
wherein the setting unit sets the carrier detection threshold at the first threshold when the elapsed time exceeds a second period.

7. The apparatus according to claim 1, further comprising one or more antennas.

8. A wireless receiving method, comprising:
detecting a wireless frame which has a received power level higher than a carrier detection threshold when the wireless frame is received;
performing demodulation on the wireless frame;
determining a connection status between the wireless receiving apparatus and another apparatus in accordance with whether or not the demodulation is successful;
setting the carrier detection threshold at a first threshold if the connection status is an initial status where demodulation of a connection request frame is not successful and setting the carrier detection threshold at a second threshold if the connection status is other than the initial status, the first threshold being a fixed value, the second threshold being a variable value and larger than the first threshold.

9. The method according to claim 8, further comprising measuring a received power value of the wireless frame for which the demodulation is successful,
wherein the setting the carrier detection threshold determines the second threshold based on a required signal-to-interference noise ratio and the received power value if the connection status is other than the initial status.

10. The method according to claim 9, wherein if one or more successfully-demodulated wireless frames are acquired, the setting the carrier detection threshold determines the second threshold using a received power value of a latest wireless frame among the one or more successfully-demodulated wireless frames.

11. The method according to claim 9, wherein if one or more successfully-demodulated wireless frames are acquired, the setting the carrier detection threshold calculates an average of the received power values of the one or more successfully-demodulated wireless frames, and determines the second threshold based on the average.

12. The method according to claim 8, further comprising receiving one or more wireless frames;
wherein a frame length of the connection request frame is shorter than a frame length of a data frame, and one or more connection request frames are successively transmitted from the another apparatus at a first interval within a first period,
if the connection status is the initial status, the setting the carrier detection threshold successively receives the one or more connection request frames until the demodulation is successful.

13. The method according to claim 8, further comprising measuring an elapsed time if the connection status is a connection establishment status where a connection between the wireless receiving apparatus and the another apparatus is established, the elapsed time being a time since the connection status has been shifted to a connection establishment status, or a time since the demodulation has been successfully performed,
wherein the setting the carrier detection threshold sets the carrier detection threshold at the first threshold when the elapsed time exceeds a second period.
